(19) United States
(12) Patent Application Publication
(10) Pub. No.: US 2005/0049892 A1
(43) Pub. Date: Mar. 3, 2005

(54) System and method for supply chain collaborative risk management

(76) Inventors: Charles J. Miller, Berkeley, CA (US); Yair Frankel, Westfield, NJ (US); Noah J. Rosenkrantz, Cambridge, MA (US)

Correspondence Address: REED SMITH LLP, 2500 One Liberty Place, 1650 Market Street, Philadelphia, PA, 19103-7301, US

(21) Appl. No.: 10/895,014

(22) Filed: Jul. 20, 2004

Related U.S. Application Data
(60) Provisional application No. 60/488,767, filed on Jul. 22, 2003.

(51) Int. Cl. G06F 17/60

(52) U.S. Cl. 705/1

(57) ABSTRACT

A method, apparatus, and system for supply chain collaborative risk management of a cargo container. The invention includes a first entity for collecting data relevant to risks associated with the cargo container, and a second entity for receiving the data from the first entity, wherein the second entity combines the received data with risk relevant data and makes a determination of the risk of the cargo container.

### BACKGROUND OF THE INVENTION

1. Field of the Invention

The invention relates to the field of supply chain management, and more particularly, to collaborative risk management in a supply chain.

2. Description of the Background

Trading of goods is often subject to risk. For example, shipping goods internationally may be subject to various risks, including, inter alia, theft, smuggling of people (including terrorists) or contraband, cargo tampering, or terrorist delivery of nuclear, radiological, biological, chemical or conventional explosives, materials or weapons. Securing the global supply chain may be difficult because legal and physical control of goods in transit typically changes between various entities, such as manufacturers, sellers, brokers, financiers, truckers, ocean carriers, certain integrated logistics providers, customs house brokers and buyers, for example. Arranging global logistics has thus become increasingly complex, as various entities may be involved and may contribute relevant risk information, including freight forwarders, third party logistic providers and lead logistics providers, for example.

The facilities, equipment, processes and systems that make up the global supply chain may be monitored for risk factors to permit decision makers to determine whether a particular container represents a level of risk along a risk continuum measured in severity from, for example, acceptable to unacceptable. By correctly analyzing and ranking risk, companies and governments may be enabled to concentrate response resources on higher risk or identified-as-potentially-dangerous or dangerous shipments. The ability to share certain information up stream and down stream in the supply chain, and across supply chains, to thereby allow for supply chain participants to collaboratively manage risk, may be a key to increasing supply chain security overall.

The need to share information may be acute. The global shipping industry, like the global airline industry, attempts to serve its customers by having regular schedules and sufficiently frequent service to address customer needs. However, few, if any, ocean carriers operate sufficient equipment to provide necessary service coverage. Thus, Ocean Carriers often make cargo carrying arrangements collaboratively to extend their respective coverage. In practice, almost every Ocean Carrier books containers that are then carried on a competitor's ships.

Other business models may raise information sharing requirements, and subsequently tensions, among companies that book cargo and companies that carry it. For example, there is a class of businesses known as non-vessel operating common carriers (NVOCCs) which may take possession of cargo directly from an end user and issue a bill of lading to the customer in exchange for the cargo. Often the NVOCC does not operate a vessel, and therefore, consigns the cargo to a carrier in exchange for a subsequent bill of lading. In this instance, certain customer and container data may reside with the NVOCC.

Information sharing also arises in the context of load consolidation. Many people attempt to ship goods that do not completely fill a container load. Consolidators may become involved and issue a bill of lading or other ownership document to a customer, and may attempt to consolidate a number of loads into a single container, thereby filing the shipping compartment. In such a configuration, the consolidator may hold the customer and cargo data.

Carriers may carry on their ships a significant percentage of cargo for other carriers, NVOCCs and consolidators. This cargo may be carried on a common carriage basis, that is, the container must be accepted for carriage if the freight is paid and there is no good basis upon which to refuse carriage.

The risk profile of a particular container may be affected by a number of factors. The data associated with the factors may be held by a number of different entities; yet, all of it may be important to determining whether a container should be permitted to be laden upon a container ship, delivered to a port, or released from a government's custody. Moreover, determining aggregate risk through analysis of the risk profile of single container may not be sufficient. Relationships amongst multiple containers and other factors may be necessary to determine the overall risk of an undesirable event. Risk related data may be generated or held by a number of different entities.

Therefore a need exists to provide for security and risk information transfer between and amongst supply chain participants for decision support, and/or for liability bearing representations regarding compliance to security or risk standards to be made from one supply chain participant to another, either directly or through intermediaries.

Further, companies participating within the global supply chain may be requested to address security concerns, such as in the event of a terrorist threat potential. But there is no standard to be met in this situation, and therefore it is difficult for companies to know what to do. Shipped cargo often moves through certain choke points, such as consolidation centers, container yards, ocean terminals and container ships, where cargo from one supply chain may be intermingled with cargo from other chains. Secure supply chains may be exposed to certain risks resulting from proximity to cargo being moved in a less secure fashion. Spending to increase the security of one chain or the chain of one company may not be effective, as the determining factor is the weakest link. Therefore all companies incident on a supply chain must be subject to similar standards. Without mandatory or optional standards and guidelines, companies my be left to individually determine the sufficiency of security, leaving such companies open to legal liability for not doing enough in the event of an incident, while disincentivizing doing more because spending more on security than one's competitors may put one at a business disadvantage. It may be desirable that all parties be working to a common baseline of security practices. The carrying entity may be required to carry cargo booked by a separate booking entity and tracked by a separate tracking entity, and may prefer to understand that the security and risk related procedures followed by these other entities are sufficient to meet the security and risk requirements of the carrying entity.

Therefore a need exists to permit the supply chain community, in conjunction with national, international or other agency requirements, standards or regulations, to standardize upon a known set of common practices, which practices may contain risk differentiated practices based on discriminators such as region or other risk factor.

The effort to implement collaborative risk management in a supply chain context may be complicated by the fact that certain of the participants in a single supply chain may be competitive with one another. For example, it is embedded in the ocean carriage business model that carriers, NVOCCs, consolidators and others book container passage with carriers either on a spot basis or pursuant to forward contracts. A booking entity may desire to withhold information from the carrying entity, particularly customer data, for fear of circumvention, such as the carrying entity attempting to circumvent the booking entity and communicate directly to the customer.

Therefore a need exists to permit companies to protect commercial privacy while also providing sufficient security or risk related information or representations to carrying entities to comply with any external or internal compliance requirements.

The insurance world may compare premiums and related revenues against payouts due to occurrences and related expenses in determining whether to provide a line of insurance cover. This determination may be difficult in terms of terrorism related risks. Unlike natural occurrences, terrorist acts cannot be predicted in terms of number of events or magnitude of associated losses. In addition, particular risks may not be covered, such as nuclear or certain radiological risks, for example. These particular risks tend to be considered catastrophic risks for which insurance coverage cannot be economically provided. As may be known to those possessing an ordinary skill in the pertinent arts, financing agencies, such as banks, for example, may be sensitive to risk parameters within their customer base, and financing costs may vary based on compliance or level of compliance. Both buyers and sellers may wish to monitor for risk factors that may affect performance either in delivering goods or in making payments. Another consideration is that various entities may wish to limit the risks taken as compared to other entities within the system.

Therefore a need exists to permit risk transfer companies to disseminate and enforce, including, perhaps, through near interval or real time monitoring, certain standard practices as a pre-condition or as an on-going condition to obtaining and retaining coverage, financing or terms. Further, a need exists to permit the system, or any nodes within it, to set risk acceptance practices based on policy or risk sensitive considerations.

A portion of the risk that may be addressed in making decisions within any system may be the knowledge of whether data originated with an authenticated and authorized source and whether data from an authenticated and authorized source is received uncorrupted or without unauthorized changes.

Therefore a need exists to integrate tools and methods for reducing risk by preventing and detecting unauthenticated persons, devices or processes attempting to introduce information into the system, as well as assuring that data is not altered without appropriate authorization or corrupted in a manner that cannot be detected.

Risk information relevant to a particular shipment or supply chain element may be held by various parties that have costs associated with the collection of that information. This information may be valuable and other entities may wish to purchase it on some commercial basis. Formalized mechanisms for structuring, pricing and exchanging this information may not be available. Therefore a need exists to permit incorporation of pricing models for information into the data exchange protocols.

### SUMMARY OF THE INVENTION

The present invention includes a method, apparatus, and system for supply chain collaborative risk management of a cargo container. The invention includes a first entity for collecting data relevant to risks associated with the cargo container, and a second entity for receiving the data from the first entity, wherein the second entity combines the received data with risk relevant data and makes a determination of the risk of the cargo container.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates a diagrammatic representation of the roles, flows and organization of the present invention;

FIG. 2 illustrates a diagrammatic representation of the standards creation and implementation of the system of FIG. 1;

FIG. 3 illustrates a privacy, compliance, aggregation and payment representation according to an aspect of the present invention of the system of FIG. 1;

FIG. 4 illustrates a risk transfer, information aggregation and trust infrastructure of the system of FIG. 1 according to an aspect of the present invention; and,

FIG. 5 illustrates a specific embodiment of the system of FIG. 1.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical supply chain management systems and methods of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

A system for, among other things, discovering and analyzing such risks and placing them along a severity based continuum, is disclosed in provisional patent application entitled “A SYSTEM AND METHOD FOR PROACTIVE RISK DETECTION SYSTEM, REPORTING AND INFRASTRUCTURE,” with inventors Frankel, et al. and identified as U.S. patent application Ser. No. 60/476,628, the entirety of which is incorporated herein as if set forth in its entirety.

The risk profile of a particular container may be affected by a number of factors such as, among other things, the location or ownership of a facility or conveyance where the container is stuffed, stored, moved with or moved through; the backgrounds of any persons with access to a container or the goods that were stuffed in it anywhere along the path of travel; the policies, procedures and practices in place to prevent or detect unauthorized additions to or deletions from cargo; or tamper evidence data taken directly from the container while in transit. The data associated with the above factors may be held by a number of different entities; yet, all of it may be important to determining whether a container should be permitted to be laden upon a container ship, delivered to a port, or released from a government's custody.

Moreover, determining aggregate risk through analysis of the risk profile of single container may not be sufficient. Relationships amongst multiple containers and other factors may be necessary to determine the overall risk of an undesirable event, such as terrorism where a terrorist has may have sufficient knowledge to split shipments constituting attacks into multiple containers each of which individually may appear benign but in combination which may result in a threat, for example.

Risk related data may be generated or held by a number of different entities. Information about the parties to the transaction, for example, the identity of and information about the importer, consignee, source manufacturer, or seller, may be in the possession of the entity that books passage of a container. Information about the facilities where the container is stuffed or stored in transit may be held by any number of parties, or by third party auditors or assessors working on their behalf. Information about containers en route may be held by the in-land carrier, such as a truck, rail, or barge, hauling the container, while information about the loading or unloading terminal, the boat itself and its route may be held by a carrying entity or a tracking entity. Yet, a sufficient amount of this information must be available to the carrying entity, and perhaps to governmental authorities, so that an appropriate risk based decision may be made whether to carry a particular container. Moreover, under current regulatory schema, a carrier, or NVOCCs, may be, pursuant to the 24 Hour Advance Manifest Rule, responsible for submitting certain security related information to the US Customs authorities for containers going into a United States controlled port whether off-loaded or not.

Shipped cargo often moves through certain choke points, such as consolidation centers, container yards, ocean terminals and container ships, where cargo from one supply chain may be intermingled with cargo from other chains. Secure supply chains may be exposed to certain risks resulting from proximity to cargo being moved in a less secure fashion. Spending to increase the security of one chain or the chain of one company may not be effective, as the determining factor is the weakest link. Therefore all companies incident on a supply chain must be subject to similar standards. It may be desirable that all parties be working to a common baseline of security practices. The carrying entity may be required to carry cargo booked by a separate booking entity and tracked by a separate tracking entity, and may prefer to understand that the security and risk related procedures followed by these other entities are sufficient to meet the security and risk requirements of the carrying entity. While various means of accomplishing this may be contemplated, according to an aspect of the present invention, security and risk standards may be followed according to a baseline.

The effort to implement collaborative risk management in a supply chain context may be complicated by the fact that certain of the participants in a single supply chain may be competitive with one another. For example, it is embedded in the ocean carriage business model that carriers, NVOCCs, consolidators and others book container passage with carriers either on a spot basis or pursuant to forward contracts. A booking entity may desire to withhold information from the carrying entity, particularly customer data, for fear of circumvention, such as the carrying entity attempting to circumvent the booking entity and communicate directly to the customer.

The insurance world may compare premiums and related revenues against payouts due to occurrences and related expenses in determining whether to provide a line of insurance cover. This determination may be difficult in terms of terrorism related risks. Unlike natural occurrences, terrorist acts cannot be predicted in terms of number of events or magnitude of associated losses. However, there is a strong policy initiative for insurance companies to offer coverage for terrorist acts, as evidenced by the United States' Terrorism Risk Insurance Act of 2002 (TRIA). The TRIA provides a mechanism requiring insurance companies to offer terrorism coverage, but which also provides a $100 billion of governmentally provided indemnity backstop.

In addition, particular risks may not be covered, such as nuclear or certain radiological risks, for example. These particular risks tend to be considered catastrophic risks for which insurance coverage cannot be economically provided. However, it is in the interests of government, business and the public that commercial risk transfer products take on at least part of this risk, even if some of the risk must be eventually laid off on public sector back stop. Underwriting standards and monitoring for compliance may be a key to controlling these risks. As may be known to those possessing an ordinary skill in the pertinent arts, financing agencies, such as banks, for example, may be sensitive to risk parameters within their customer base and financing costs may vary based on compliance or level of compliance. Banks may wish to monitor certain information, or receive representations regarding certain information or practices, in order to set, maintain or adjust financing rates.

Another consideration is that various entities within the system may wish to limit the risks taken as compared to other entities within the system. For example, one node within the system may wish to limit the type of information it accepts from another node or may wish to limit the dollar value of transactions that it is a party to with respect to another node. These limits may be set on a system wide basis or bilateral basis between nodes.

A portion of the risk that may be addressed in making decisions within any system may be the problem of knowing whether data originated with an authenticated and authorized source and whether data from an authenticated and authorized source is received uncorrupted or without unauthorized changes. Various techniques exist within communications based infrastructures to address source authenticity and data integrity. Such techniques include, but are not limited to, symmetric and public key cryptography, for example. Public key cryptography may include both certificate based, such as VeriSign certificates, and certificate-less based approaches, such as account authority based digital signatures models including the known Account Authority Digital Signature Model. Other methods are well known to practitioners of the art.

Risk information relevant to a particular shipment or supply chain element may be held by various parties that have costs associated with the collection of that information. This information may be valuable and other entities may wish to purchase it on some commercial basis. Formalized mechanisms for structuring, pricing and exchanging this information may not be otherwise available. Pricing mechanisms may include payments made to data providing entities by data consuming entities. Also, fees may be paid to and between various elements within the systems that provide information into the system.

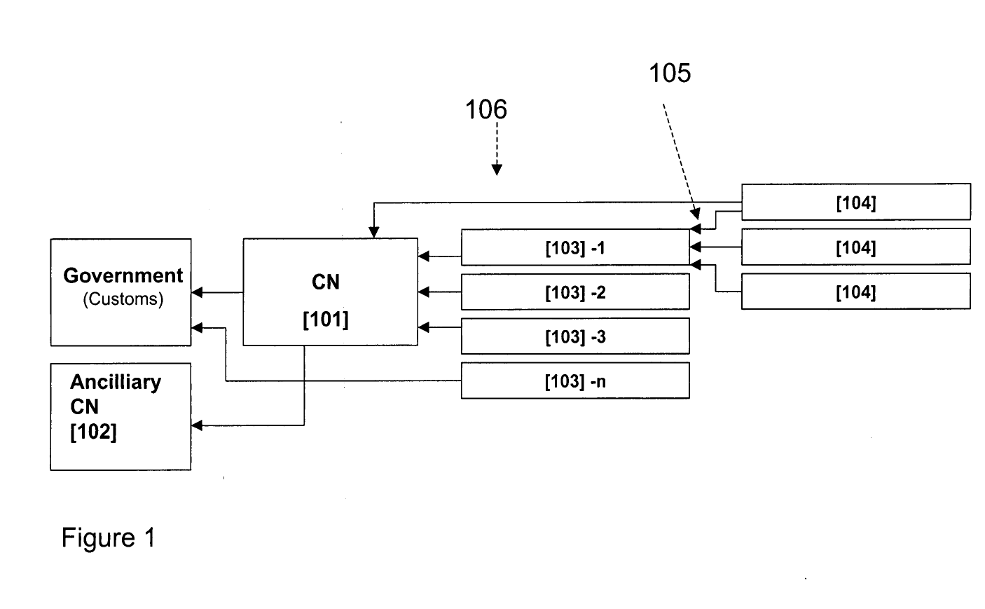

Referring now to FIG. 1, there is shown a diagrammatic representation of the roles, flows and organization of the present invention. As may be seen in FIG. 1, system 100 includes a central node 101, at least one ancillary central node 102, at least one first tier company 103 and at least one second tier company 104 communicatively coupled via aggregation nodes 105 and at least one aggregation node of last resort 106. The government is also shown, as will be discussed in more detail hereinbelow.

System 100 may be an aggregation of all nodes, which may be bound by some type of arrangement, such as a contractual network, and which share risk related data pursuant to the rules governing system 100. The rules of system 100 may be a contractual relationship that define, at a minimum, one or more operational procedures, risk standards, and response protocols.

Central node 101 may be the top level entity within system 100. Central node 101 may be responsible for, among other things, disseminating, or permitting dissemination of, risk policy for all nodes within the domain of central node 101. Central node 101 may further act as the information aggregator of last resort for commercial privacy purposes.

Central node 101 may be composed of a single entity as shown in FIG. 1, or may be a group of entities working in concert through some known mechanism or arrangement. Central node 101 may interface with other ancillary central nodes 102 that perform certain functions, such as making a determination regarding insurance or other specialized or subject matter expertise. Central node 101 may be defined against well defined functions or against roles within a system. For instance, an insurance company may define a central node CN1 to insure its policy holders and a central node CN2 may be for another Insurance policy, while central node CN3 may be an industry association which specifies and monitors specific member controls to obtain, for example, preferred regulatory treatment. Moreover, CN1, CN2, CN3 may be working within a global CN-GLOBAL that covers all entities. By way of a further non-limiting example, central node 101 may perform a self-monitoring role within the system and determine whether certain portions of system 100 have been corrupted or have inappropriately changed state, and may respond with appropriate action. For the sake of clarity and ease of understanding, the present invention is discussed utilizing a single central node 101, while it is understood that multiple central nodes working in concert may similarly be used.

Participation of entities in system 100 may or may not be tiered, with differently tiered memberships having different requirements or privileges. While FIG. 1 shows a tiered environment, it would be evident to one skilled in the pertinent arts that a single tier may be used. In tiered environments, lower tiered entities may be brought in by one or more higher entities in the chain through the rules specified by central node 101. According to an aspect of the present invention, there may be two tiers 103 and 104, one consisting of larger companies with highly automated operations, and a second layer of smaller companies that use the use the technology of others, including first tier companies 103, on an outsource basis. For example, according to an aspect of the present invention, major carriers may belong to first tier 103. Smaller companies which obtain booking or track and trace functionality from the major carriers may be second tier companies 104. Central node 101 may be responsible for identifying the appropriate characteristics of any tiered membership.

As part of its function, central node 101 may define one or more sets of data elements that constitute a set of information, preferably a full set, for risk management purposes in regard to cargo. According to an aspect of the present invention, aggregation node(s) 105 may take responsibility for the aggregation of risk related information across the population of participants involved in a particular shipment. Aggregation node 105 may be any entity within system 100 that aggregates risk related information from at least one entity other than itself. A party in system 100 may object to a particular aggregation node on the grounds of commercial privacy or other similar reason. Upon objection, which may be recorded or understood in many ways that will be apparent to those possessing an ordinary skill in the pertinent arts, aggregation node 105 for that information shifts in a fashion defined in the system rules, possibly until central node 101 acts as the neutral aggregation node of last resort 106.

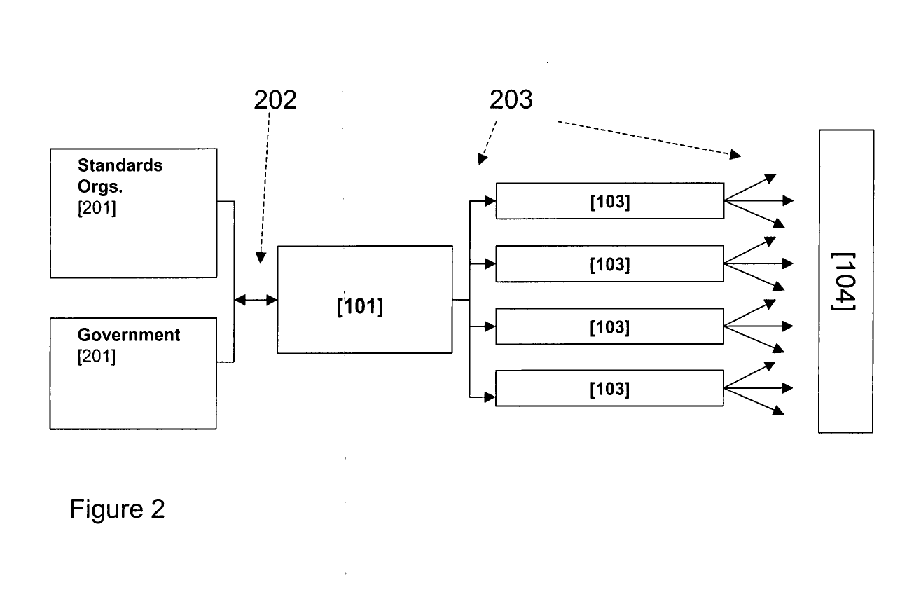

Referring now also to FIG. 2, there is shown a diagrammatic representation of the standards creation and implementation of the system of FIG. 1. As may be seen in FIG. 2, system 100 may further include at least one standards organization 201, which may include the government, a set of global standards 202 developed through the interaction of at least one standards organization 201 and central node 101, and processes and procedures 203 developed according to the system rules.

The standards promulgated by central node 101 may be acceptable to other stakeholders in the system, which may include national governments concerned with border policy, non-governmental organizations that have undertaken to draft supply chain related risk or security rules in conjunction with governments or other parties, insurers, financiers, and others who may be asked to take on security obligations or risk transfer within the supply chain, by way of non-limiting example only. Central node 101 may be responsible for adopting policy and standards for system 100 as promulgated through the system rules. Central node 101 may negotiate with standards-making stakeholders to obtain a globally acceptable set of standards 202.

Central node 101 may be responsible for developing processes and procedures 203 for bringing entities into system 100 through bilateral execution of contracts that bind each entity to the system rules. System 100 may contemplate criteria for participation eligibility within system 10, which may be developed by central node 101 and the members, standards organizations 201, or external entities, such as government regulators.

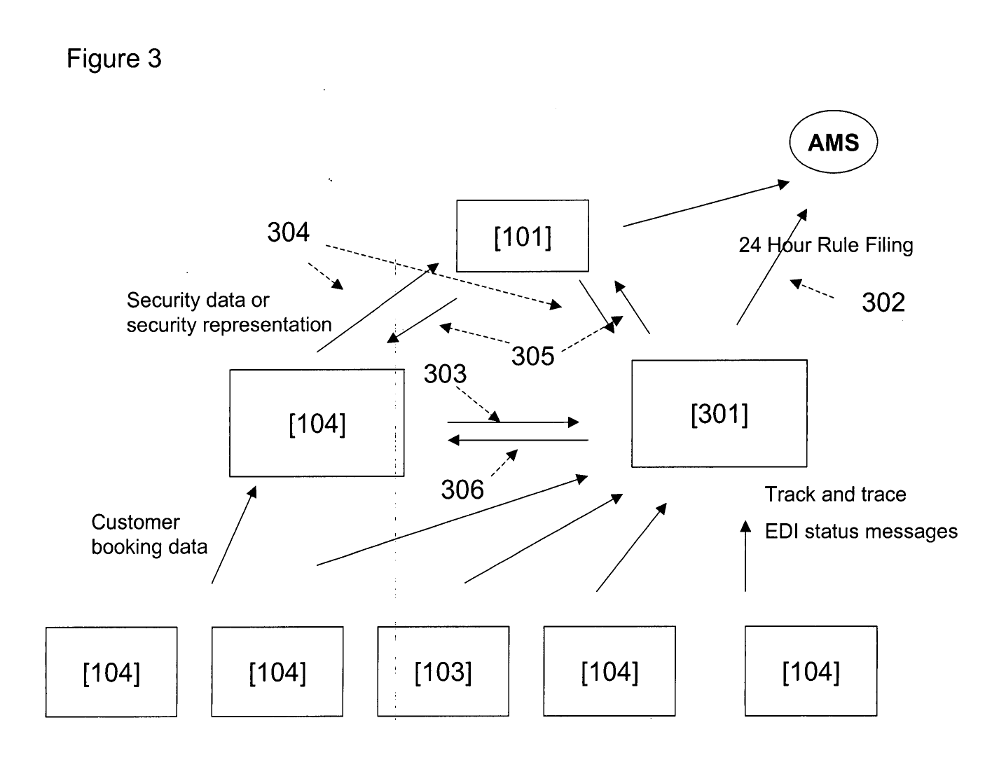

Referring now to FIG. 3, there is shown a privacy, compliance, aggregation and payment representation according to an aspect of the present invention and to the system of FIG. 1. An NVOCC hired by the booking entity, which may be the entity in an international trade transaction that takes an order to book passage of a container or other cargo, for example, for a particular container headed to the United States. In this role the NVOCC may have certain customer information that it prefers not to provide to the carrying entity 301, the entity that operate the transporter of the cargo. Carrying entity 301 may require that the customer name be screened against denied party lists prior to agreeing to carry the container. Carrying entity 301 may also have a responsibility to submit the identity of the customer to a government authority 201, such as the United States Bureau of Customs and Border Protection, for example, through an electronic interface 307. Such an advance manifest system 302 may be created to comply with the U.S. 24 Hour Advance Manifest Rule, or other similar rule known to those possessing an ordinary skill in the pertinent arts. Within system 100, carrying entity 301 may be required either to review data that demonstrates compliance with its security requirements by booking and tracking entities, if those entities are not identical with carrying entity 301, or it may be required to rely upon a liability backed representation 303 that the representing entity is in a compliant state. Central node 101 may also, or in the alternative, make the representation 304 to the relying entity. Central node 101 may define instances in which it is the only entity that can make a particular representation or class of representations, or combinations thereof.

Various entities within the infrastructure may wish to make certain risk or security related representations, either publicly or to others within the system. System 101 may provide an ability to make such representations and to charge or be charged for them on a system wide 305 or peer to peer basis 306.

Similarly, key escrow type mechanisms may be deployed to hide information, not necessarily identity information, at carrying entity 301. In this case, the identity or other information may be encrypted in a manner in which, for example, a government entity 201 may decrypt to determine its original form. Key escrow technology that as has been developed in the area of cryptography and data security includes threshold schemes, secret sharing and other techniques. Central node 101 may establish the rules, processes and mechanisms to enforce escrowing where necessary. In some cases, entities in the system will be required to prove electronically, such as through cryptographic and data security proof mechanisms, that the entity operated the escrowing in a proper manner. Another mechanism to hide information may be the use of pseudonyms.

In the reverse direction, entities querying the system may require hiding their request. For instance, law enforcement personnel working in a global system may want to keep their queries confidential. The use of private information retrieval techniques may be used to hide record queries. In addition, infrastructure may be developed to hide the entity making requests through the use of protective techniques, such as onion routing, known in the field of cryptography and data security, for example.

Aggregation nodes 105 may be decision nodes, points at which a risk related decision in regard to a container must be made. Decision nodes may be an entity within system 100 that may make a decision whether to allow a transaction to proceed in a customary fashion, or how to proceed and at what cost, in regard to risk related information received from system 100 participants or others. For example, carrying entity 301 may decide whether to agree to carry a particular container, or the conditions under which it will agree to carry such a container. Other decision nodes may include, among others, central node 101, the outbound logistics provider, the importer, the consignee, the customs house broker, the insurer, the financier, a government agency or a terminal, by way of non-limiting example only.

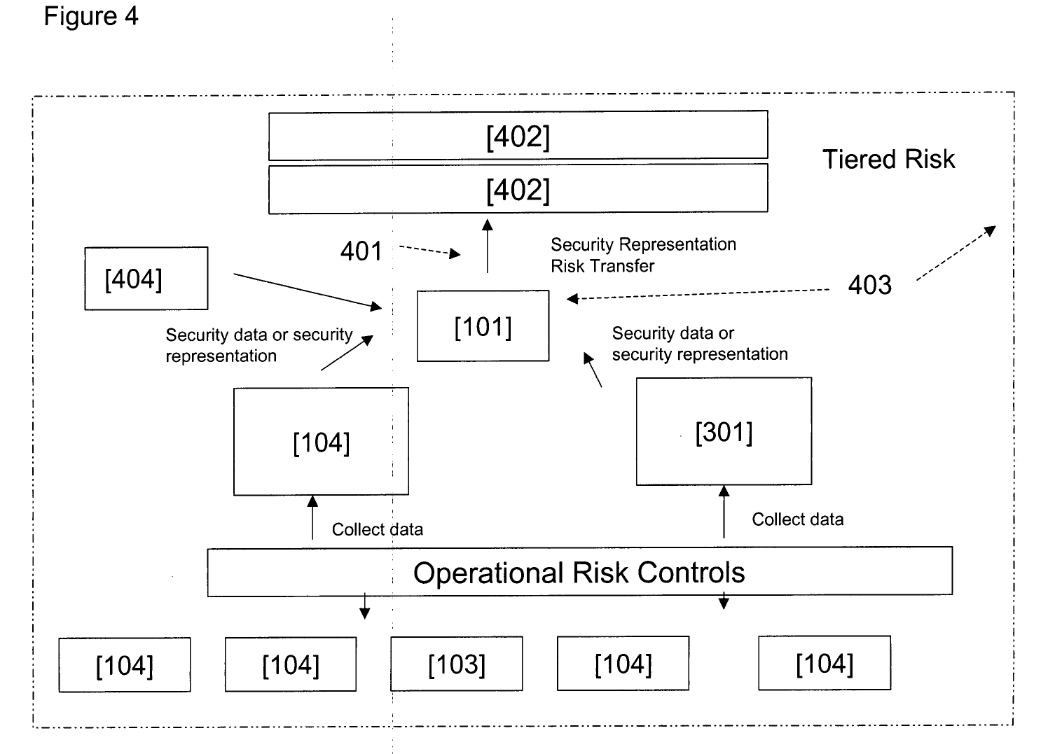

Referring now to FIG. 4, there is shown the risk transfer, information aggregation and trust infrastructure of the system of FIG. 1, according to an aspect of the present invention. Decision node may decide whether to carry a container or set conditions for carriage based upon risk related information or liability bearing representations received. Central node 101 may decide to nominate 401, 402 the container for certain types of insurance coverage based on information and liability bearing representations as to information states received. Similarly, an underwriting entity may decide whether to offer coverage to a particular container, cargo or shipment based upon aggregate information received through system 100 or upon liability bearing representations regarding certain information states received through the System. Which decision node decides to carry may be determined through a number of possible aspects, including region of container, insurance carrier, home port, destination port, type of cargo, by way of non-limiting example only. In making the decision, the decision node may rely either upon information it receives and analyzes and/or upon a liability bearing representation that a certain security or risk compliance state has been achieved in regard to a particular cargo, container or shipment. The analysis for a single container may be based on other information about other containers or shipments obtained by system 100, or by reference to facts surrounding other shipments to ensure a broad view is taken for evaluating the granular risk of a single container 403. The failure of a representation to be true may be met with exoneration of any liability by any entity that made a decision to accept risk based upon the representation, as well as with grounds to claim back against the node generating the failed representation. System rules may also provide for certain reserves or collateral to be provided by member entities to back stop failed representations.

Though decisions may be real time, it is anticipated “reversals” or “mitigating actions” are possible after a decision is made. That is, the decision to allow a supply chain process to proceed, such as the loading of a container onto a ship, may be made; however, due to information unknown at the time the “allow” decision is made, subsequent information which indicates that the container represents a greater risk than previously believed, in essence, a reversal or a mitigation, may be performed. If, as in the present example, the shipment is in-transit, a reversal may not be possible or practical and other mitigating actions may be initiated such as unloading at the nearest port or examination while on board by crew or other risk and security experts. By way of example, after loading a container when a ship is in transit, it is determined through newly developed intelligence that the entity that loaded the container is related to a terrorist organization. It may then be necessary, despite any previous “allow” or “load” decision, to re-evaluate the past decisions, and make new ones based on the current perception of the risk and initiate reversing or mitigation actions based on the new data.

Compliance with security policy as implemented within the system rules may make a container eligible for nomination for certain insurance coverage. For example, rule compliance may be a pre-condition to obtaining liability insurance for the container, or may be a pre-condition for having a terrorism or nuclear exclusion waived or otherwise having such coverage provided.

Data passed between system nodes may be protected against interception or tampering and authorized persons or systems at the nodes should be subject to appropriate levels of authentication. System 100 may support the use of computer security techniques such as, but not limited to, encryption, access control mechanisms, error correction protocols, etc. to achieve these objects, by way of non-limiting example only. According to an aspect of the present invention, each person, device or process within the invention may be issued cryptographic tokens or other materials after appropriate identification 403 of the person, device or process. This token or material, when correctly presented, may authenticate 403 the person, device or process. Cryptographic techniques, known to those possessing an ordinary skill in the pertinent arts, may be used to assure that data is not altered without authorization or otherwise corrupted in a non-evident manner. When authentication technology involves the use of public key cryptography techniques, public keys may be kept in a central directory and not disseminated in certificates, and the public key linked to permissions and other relevant data may be held in a directory.

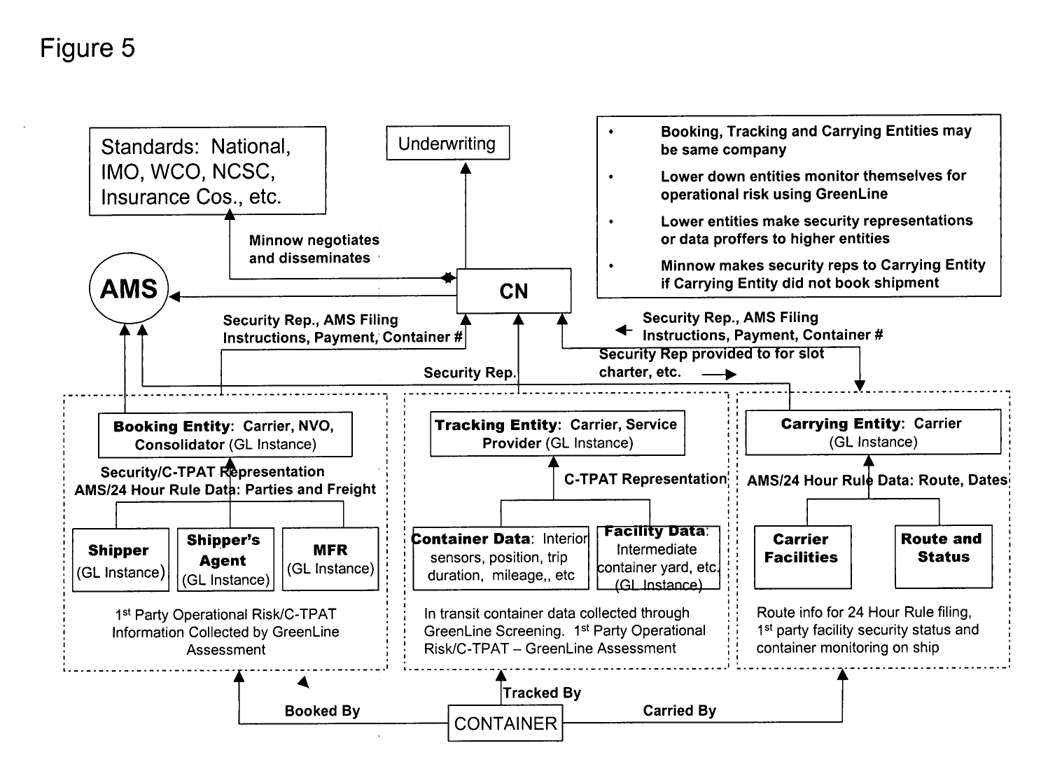

Referring now to FIG. 5, there is shown a specific embodiment of the system of FIG. 1. System 500 may include a central node 501 that disseminates policy regarding security risk associated with cargo in international trade, and a set of system rules to govern the behavior of all actors within system 500. Central node 501 may act as an information cut-out between commercial entities to protect competitive information. The ability for any node to act as the information cut-out for other nodes may be defined in the system rules. A set of nodes, including central node 501, may receive representations regarding a security state, and may be authorized on behalf of the representing party to pass the representation on transitively to a relying party. This provides the ability to set policy among nodes, either on a system wide, bilateral or multilateral basis, to address acceptable counterparty risks in accepting or acting upon data. Mechanisms may be present to permit systems to communicate on a peer to peer basis to demand or request payment for, or make payment for, provision of certain information, and which may be used as an information pricing mechanism. An authentication and security infrastructure to prevent and detect improper persons, entities, devices and processes from participating within the system, and to assure data integrity, may be administered by or for the central node 501.

A carrying entity 502 may develop routes and status and may provide facilities to facilitate shipment. Carrying entity 502 may provide route information for the 24 hour rule filing and may be a first party facility security status and may provide container monitoring while in transit.

A tracking entity 503 may be the entity responsible for receiving data about cargo once the cargo leaves the freight station. Tracking entity 503 may provide in transit data collected through special screening and may provide container data, such as the readouts of interior sensors, position of cargo, trip duration and mileage traveled, by way of non-limiting example only. Tracking entity may include information about intermediate destinations.

A booking entity 504 may be a carrier, NVOCC, or consolidator. Booking entity 504 may include a shipper, a shipper agent, and a manufacturer, for example.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A system for supply chain collaborative risk management of a cargo container, said system comprising:
a first entity for collecting data relevant to risks associated with the cargo container;
a second entity for receiving the data from said first entity;
wherein said second entity combines the received data with risk relevant data and makes a determination of the risk of the cargo container.

2. The system of claim 1, further comprising at least one more entity, wherein said second entity further receives data from said at least one more entity and combines the received data with risk relevant data and makes a determination of the risk of the cargo container.

3. The system of claim 1, further comprising a third entity for receiving the combined risk determined from said second entity.

4. The system of claim 3, wherein said received combined risk does not include the collected relevant data.

5. The system of claim 1, wherein said second entity sets at least one policy associated with the data.

6. The system of claim 5, wherein said at least one policy at least partially governs interaction of at least one entity.

7. The system of claim 5, wherein said at least one policy partially governs how said second entity analyzes risk.

8. The system of claim 1, wherein the transfer of data is at least partially governed by at least one contractual relationship.

9. The system of claim 1, wherein the transfer of data is at least partially governed by at least one set of enforceable rules.

10. The system of claim 1, wherein the transfer of data is at least partially governed by at least one set of enforceable standards.

11. The system of claim 1, further comprising security suitable for authenticating entities.

12. The system of claim 1, further comprising security suitable for assuring the integrity of data.

13. The system of claim 1, wherein the determination of said second entity indicates acceptable risk associated with a cargo container.

14. The system of claim 13, wherein the determination of acceptable risk is a precursor to being able to obtain insurance or financing for the goods within the cargo container.
